(19) United States
(12) Patent Application Publication
(10) Pub. No.: US 2003/0060316 A1
(43) Pub. Date: Mar. 27, 2003

(54) Adjustable bicycle chain guide device

(76) Inventor: Cheng-Xun Jiang, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/963,029

(22) Filed: Sep. 26, 2001

(51) Int. Cl. F16H 27/02; F16H 31/00; F16H 55/36

(52) U.S. Cl. 474/141; 74/134

(57) ABSTRACT

An adjustable bicycle chain guide device includes a plate mounted to a crank axle and the plate has two protrusions. Two rollers each have an extension and the two extensions are respectively connected to the two protrusions. Each of the extensions has two holes defined therethrough and each of the protrusions has two rows of positioning holes so that the positions of the rollers are adjusted on the protrusions by engaging bolts with different positioning holes.

### FIELD OF THE INVENTION

The present invention relates to a bicycle chain guide device wherein the distance between the chain and the crank axle can be adjusted by the device.

### BACKGROUND OF THE INVENTION

A first conventional bicycle chain guide device 10 is shown in FIGS. 1 and 2, and generally includes two rollers 14 connected on two of three protrusions 13 of a three-protrusion member 11 which is fixedly mounted on a crank axle 18 of the bottom bracket. Each of the rollers 14 has a groove 141. A disk 12 is fixed on the three-protrusion member 11 and a chainwheel 17 is mounted to the crank axle 18. A cap 16 is connected to the chainwheel 17 and a crank 15 is fixed on the crank axle 18. The chain 19 is engaged with the chainwheel 17 and the groove 141 of each of the rollers 14. The chainwheel 17 is rotated when rotating the crank 15 and the chain 19 is driven by the rotation of the chainwheel 17. The chain 19 is supposed to be received in the grooves 141, however, the tension makes the chain 19 shake between the chainwheel 17 and the rollers 14. The chain 19 could jump out from the grooves 141 and the disengaged from the teeth 171 of the chain wheel 17. Besides, the distance between the chain 19 and the crank axle 18 can not be adjusted so that the device can only be cooperated with a specific chainwheel 17.

A second conventional bicycle chain guide device 20 is shown in FIGS. 3 and 4, and generally includes a plate 21 with two tunnel members 211 and the plate 21 is fixed to a ring 22 which is mounted to the crank axle. The ring 22 has two sets of holes 221 and 222 and the plate 21 has three fixing holes 214 which are located in alignment with the holes 221 or 222 so that the plate 21 can be connected to the ring 22. The chainwheel 26 and a cap 25 are respectively mounted to the crank axle and a crank 24 is fixed to the crank axle. The chain 27 is engaged with the chainwheel 26 and passes through the two tunnel members 211. The plate 21 can be adjusted relative to the chain 27 by connecting the plate 27 to the ring 22 at different holes 222 or 221. By the adjustment, the distance between the chain 27 and the crank axle can be changed so as to adapt a larger or smaller chainwheel 26. However, the adjustment of the plate 27 is made by rotating the plate 27 about the crank axle so that the chain 27 is pushed or pulled by one of the tunnel members 211 and the chain 27 is operated in an unstable condition.

### SUMMARY OF THE INVENTION

In accordance with one aspect of the present invention, there is provided an adjustable bicycle chain guide device which comprises a plate mounted to an crank axle and the plate has two protrusions. Two rollers each have an extension and the two extensions are respectively connected to the two protrusions.

The primary object of the present invention is to provide a bicycle chain guide device wherein the distance between the rollers and the crank axle can be adjusted.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a first conventional bicycle chain guide device;

FIG. 2 is a side view to show the first conventional bicycle chain guide device;

FIG. 3 is an exploded view to show a second conventional bicycle chain guide device;

FIG. 4 is a side view to show the second conventional bicycle chain guide device;

FIG. 5 is a side view to show that the plate of the second conventional bicycle chain guide device is rotated an angle;

FIG. 6 is an exploded view to show the bicycle chain guide device of the present invention;

FIG. 7 is a side view to show the connection of the plate and the two rollers of the bicycle chain guide device of the present invention;

FIG. 8 is a side view to show the bicycle chain guide device of the present invention, and

FIG. 9 is a side view to show that the rollers of the bicycle chain guide device of the present invention are adjusted.

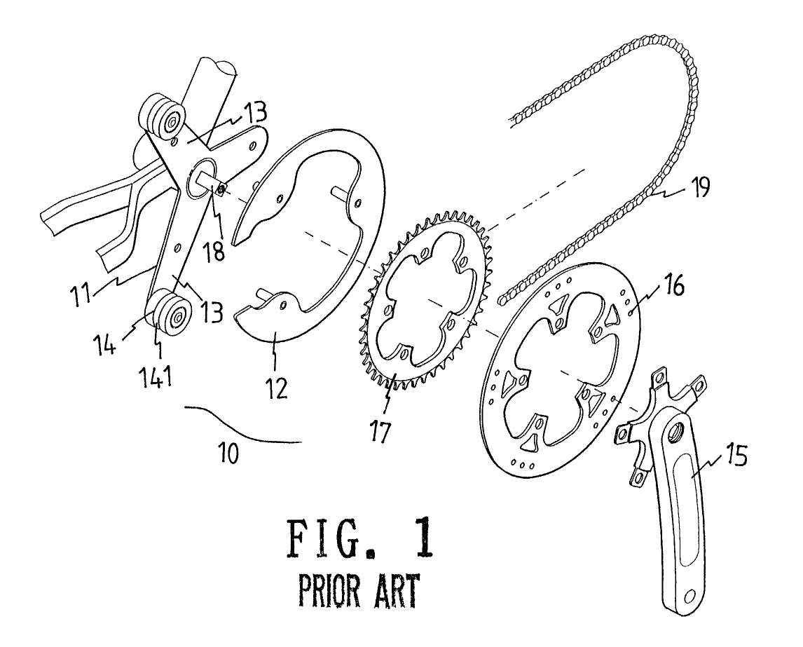

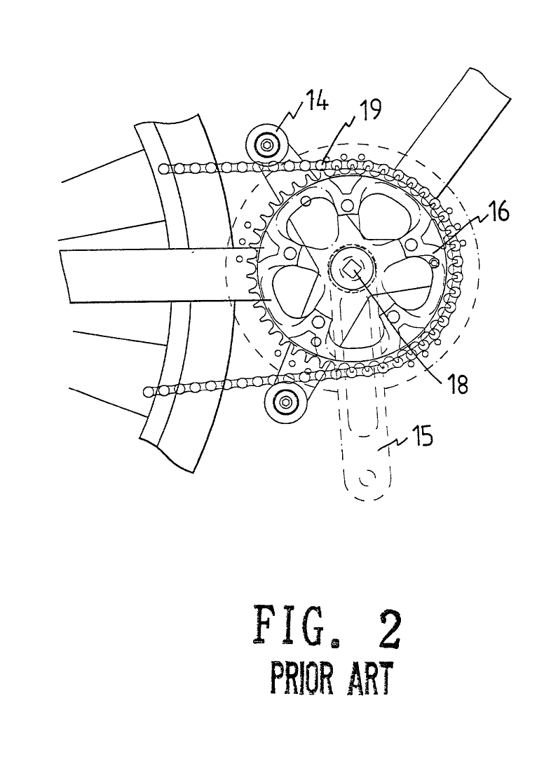

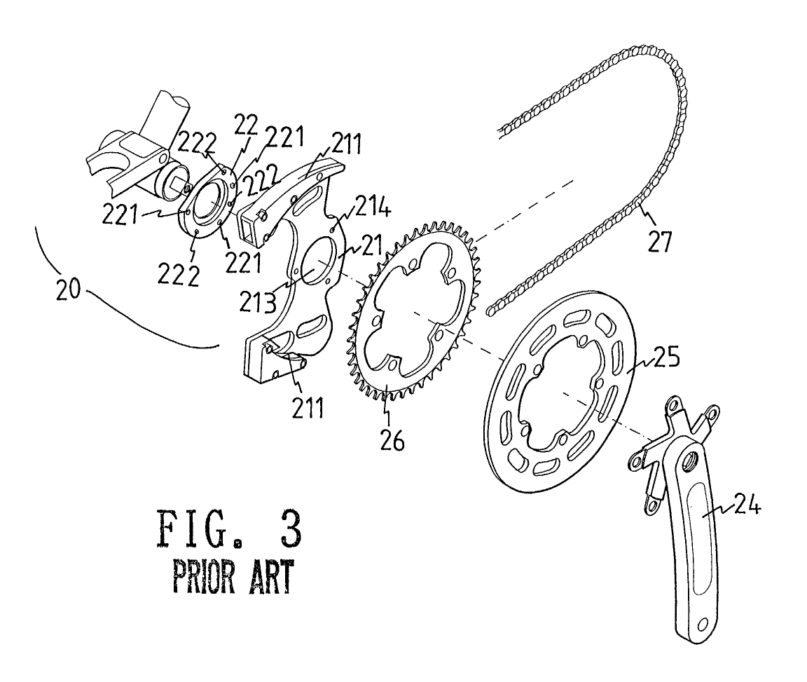

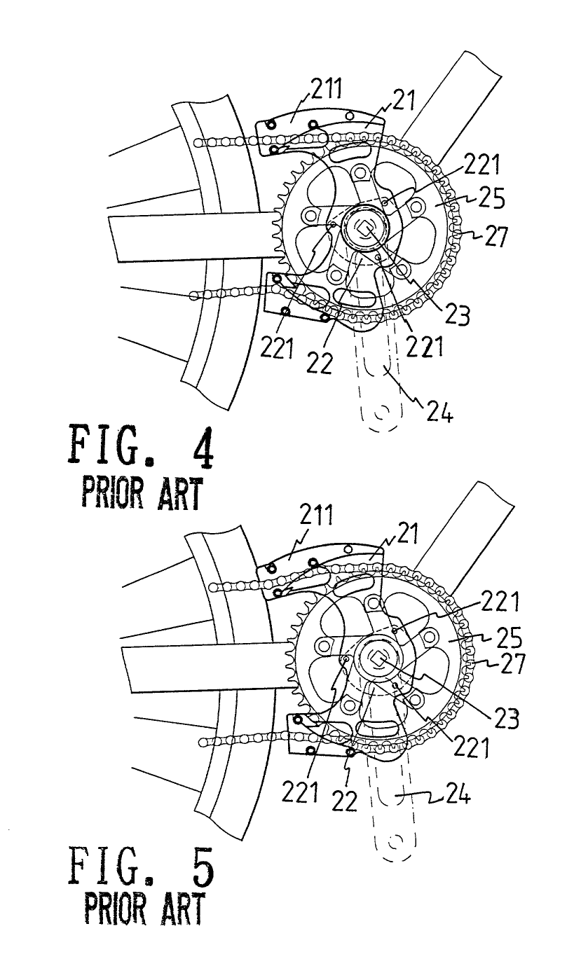

### DETAILED DESCRIPTION OF THE PREFERRED EMBODIMENT

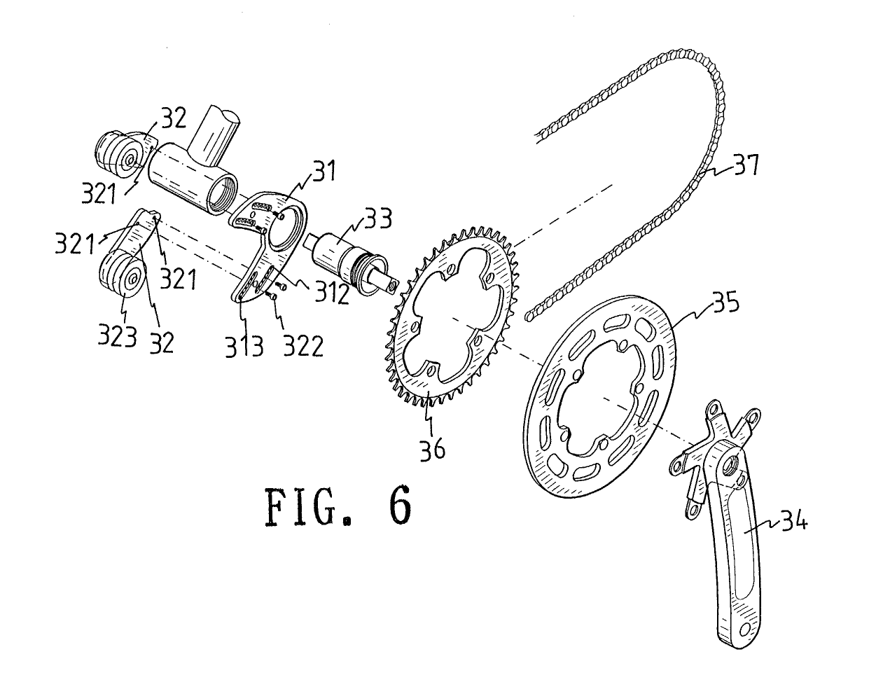

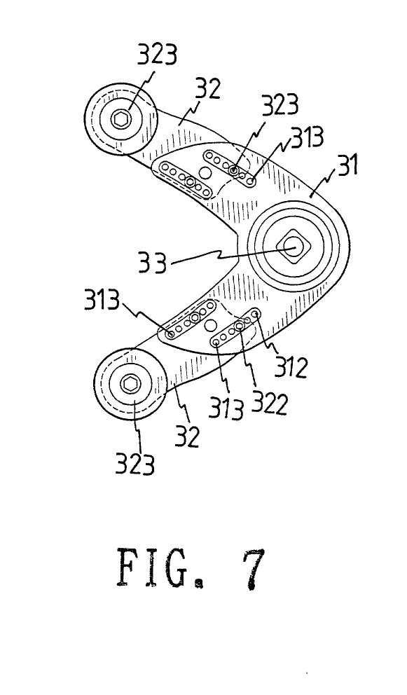

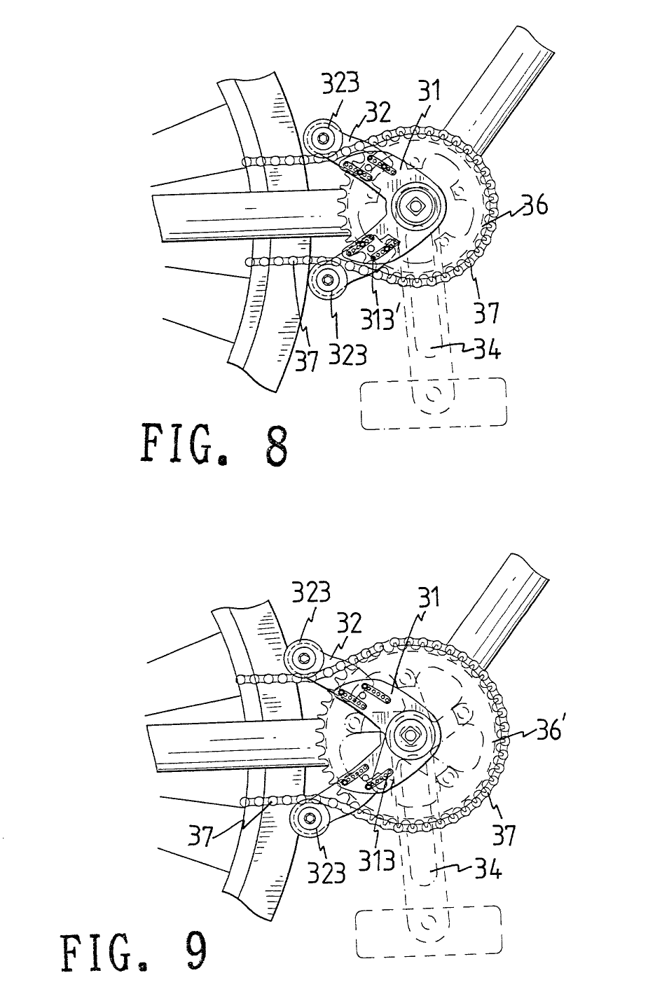

Referring to FIGS. 6 to 8, the bicycle chain guide device 30 of the present invention comprises a plate 31 mounted to an crank axle 33 and having two protrusions with an angle defined therebetween. Each of the protrusions has two rows of positioning holes 312, 313 defined therethrough in the longitudinal axis of the protrusions. Two rollers 323 each have an extension 32 and each of the extensions 32 has two holes 321 defined therethrough. Bolts 322 extend through the positioning holes 312, 313 and are engaged with the holes 321 in the extensions 32 so that the rollers 323 are connected to the two protrusions 31.

A chainwheel 36 and a cap 35 are respectively mounted to the crank axle 33 and the chainwheel 36 is located between the cap 35 and the plate 31. A crank 34 is fixed to each of two distal ends (only one is shown) so that when the cranks 34 are rotated, the chainwheel 36 is rotated and drives the chain 37.

As shown in FIG. 9, the positions of the rollers 323 are adjustable relative to the protrusions 31 by aligning different positioning holes 312, 313 with the holes 321 in the extensions 32. When a larger chainwheel 36′ is used with the chain guide device, the two extensions 32 are respectively moved outward away from the crank axle 33 so that the chain 36′ is properly retained and guided by the rollers 323. In other words, the distance between the crank axle 33 and the chain 36′ is adjustable.

While we have shown and described the embodiment in accordance with the present invention, it should be clear to those skilled in the art that further embodiments may be made without departing from the scope of the present invention.

What is claimed is:

1. An adjustable bicycle chain guide device comprising:
a plate adapted to be mounted to an crank axle and having two protrusions, and
two rollers each having an extension and said two extensions respectively connected to said two protrusions.

2. The device as claimed in claim 1, wherein each of said extensions has two holes defined therethrough and each of said protrusions has two rows of positioning holes, bolts extending through said positioning holes and engaged with said holes in said extensions.
